(19) United States
(12) Patent Application Publication
(10) Pub. No.: US 2014/0158625 A1
(43) Pub. Date: Jun. 12, 2014

(54) WATER PURIFICATION UNIT

(71) Applicants: Bhabendra Pradhan, Marietta, GA (US); Hiranmayee Vedam, Ahmedabad (IN); Thalappil Pradeep, Tamil Nadu (IN); Anshup, Lucknow (IN); Chaudhary Amrita, Varanasi (IN); Udhaya Sankar Mohan, Cuddalore (IN); Sahaja Aigal, Chennai (IN)

(72) Inventors: Bhabendra Pradhan, Marietta, GA (US); Hiranmayee Vedam, Ahmedabad (IN); Thalappil Pradeep, Tamil Nadu (IN); Anshup, Lucknow (IN); Chaudhary Amrita, Varanasi (IN); Udhaya Sankar Mohan, Cuddalore (IN); Sahaja Aigal, Chennai (IN)

(73) Assignee: NANOHOLDINGS, LLC, Rowayton, CT (US)

(21) Appl. No.: 14/110,424

(22) PCT Filed: Apr. 10, 2012
(86) PCT No.: PCT/US12/32880

§ 371 Date: Feb. 21, 2014

Related U.S. Application Data
(60) Provisional application No. 61/473,778, filed on Apr. 10, 2011.

(51) Int. Cl. C02F 1/28

(52) U.S. Cl. CPC C02F 1/281
USPC 210/660; 210/282; 210/85

(57) ABSTRACT

Disclosed herein is a sachet that can remove contaminates from a water sample. The sachet can comprise a nanomaterial. This abstract is intended as a scanning tool for purposes of searching in the particular art and is not intended to be limiting of the present invention.

### CROSS REFERENCE TO RELATED APPLICATIONS

This application claims priority to U.S. Provisional Patent Application No. 61/473,778, filed on Apr. 10, 2011, which is hereby incorporated by reference in its entirety.

### BACKGROUND

1. Technical Field

The present disclosure relates to water purification, and specifically to a water purification unit and methods for preparing and using the same.

2. Technical Background

Access to pure drinking water in some parts of the world is considered a luxury. It is estimated that waterborne diseases lead to 1.8 million deaths each year, while about 1.1 billion people in the world lack proper drinking water. Several methods to remove contaminants from water currently exist, such as UV radiation, membrane filtration methods, and chemical absorbents. Among these, chemical based methods are the cheapest to deploy.

Currently chemical based water purification is delivered in the market place in the form of gravity-fed units, in-line units, and in some cases as sachets of material which can be mixed in the water (like Pur Sachets from P&G). Delivery of chemicals for water purification in sachets has the advantage of not requiring bulky packaging materials that can hinder transportation and add to the cost of water purification. Some sachet based delivery methods involve pouring the contents of the sachet into the raw water, mixing the solution and filtering it after a prescribed settling time. This works well if the chemicals used for water purification are not reusable and dissolve in water. Thus, a need exists for improved filtration technology. This need and other needs are satisfied by the present invention.

### SUMMARY

The present invention relates to water purification, and specifically to a water purification unit and methods for preparing and using the same.

In one aspect, the present invention provides a sachet comprising a plurality of nanomaterial particles disposed therein.

### BRIEF DESCRIPTION OF THE FIGURES

The accompanying figures, which are incorporated in and constitute a part of this specification, illustrate several aspects and together with the description serve to explain the principles of the invention.

FIG. 1 shows a form of sachet which can house a water purification composition.

FIG. 2 shows sachets attached to a stirring rod. The sachet of FIG. 2a is made up of a porous membrane cloth attached to an end of a stirring rod.

FIG. 2b shows a form of water purification cartridge attached to a stirring rod. The cartridge is a hollow cylinder in which a granular water purification composition is sandwiched between two porous membranes at the end of the cylinder.

FIG. 3 shows a form of simple water purifying rod where an active composition is coated on.

FIG. 4 shows a form of sachet that can be used as filter medium. In one embodiment (FIG. 4a), the porous sachet containing a granular water purification composition is inserted inside a household funnel and contaminated water is passed through it. FIG. 4b shows a small detachable water purification cartridge is connected at the bottom of the household funnel and contaminated water is passed through it.

FIGS. 5 to 12 and 17 show the antibacterial, antiviral and fluoride removal activity of different sachets shown in FIGS. 1 to 4. The given data should not be construed for any one particular water purification composition but for all the water purification compositions.

FIG. 5 shows the antibacterial and antiviral performance of the sachet shown in FIG. 2b as a function of time. In FIG. 5, curve (a) depicts virus output concentration when input is 3×10³±50 PFU/mL, (b) depicts E. coli output concentration, when the input is 1×10⁵±1000 CFU/mL, (c) depicts E. coli output concentration, when the input is 1×10⁴±100 CFU/mL, (d) depicts E. coli output concentration, when input is 1×10³±10 CFU/mL. The antibacterial and antiviral performance of the sachet was tested separately. After contacting with the sachet, the treated water was screened for bacteria and virus at 15, 30, 45 and 60 minutes. FIG. 5 shows that near complete killing is achieved after 30 minutes and complete killing is seen after 60 minutes at rest for both bacteria and virus.

FIG. 6 shows the antibacterial and antiviral performance of the sachet shown in FIG. 2a as a function of varying E. coli and MS2 coliphage concentration. In FIG. 6 bar BI and BO represents input and output E. coli concentration, respectively. And bar VI and VO represents input and output MS2 coliphage concentration, respectively. The antibacterial and antiviral performance of sachet was tested together. Six different concentrations of bacteria and virus combination such as 10⁵ CFU/mL+10³ PFU/mL, 10⁵ CFU/mL+10² PFU/mL, 10⁴ CFU/mL+10³ PFU/mL, 10⁴ CFU/mL+10² PFU/mL, 10³ CFU/mL+10³ PFU/mL and 10³ CFU/mL+10² PFU/mL were taken for study. The bacteria and virus in the treated water was screened after 60 minutes as explained in example 1 and 2. FIG. 6 shows that the complete killing is seen after 60 minutes at rest for both bacteria and virus.

FIGS. 7 and 8 show the reusability of the sachet shown in FIG. 2a as a function of number of days. The antibacterial and antiviral performance of the sachet in 5 L of microbial contaminated water was tested daily as explained in examples 1 and 2. In FIG. 7, curve (a) shows E. coli input concentration and curve (b) shows E. coli output concentration. And In FIG. 8, curve (a) depicts virus input concentration and curve (b) depicts virus output concentration. FIGS. 7 and 8, respectively demonstrate the reusability of the sachet with sustained antibacterial and antiviral performance.

FIG. 9 shows the effect of ionic compositions of feed water on antibacterial and antiviral performance of the sachet shown in FIG. 2a. In FIG. 9, curve (a) depicts E. coli input concentration, curve (b) depicts virus input concentration, curve (c) depicts E. coli output concentration and curve (d) depicts virus output concentration. The antibacterial and antiviral activity of the sachet was together tested in three different ionic concentrations. FIG. 9 shows that at 250, 500 and 1500 μS/cm ionic conductivity, complete killing is seen after 60 minutes at rest for both bacteria and virus.

FIG. 10 shows the effect of total organic carbon (TOC) content of feed water on antibacterial and antiviral performance of the sachet shown in FIG. 2a. In FIG. 10, curve (a) depicts E. coli input concentration, curve (b) depicts virus input concentration, curve (c) depicts E. coli output concentration and curve (d) depicts virus output concentration. The antibacterial and antiviral activity of the sachet was together tested in three different TOC concentrations. FIG. 10 shows that at 1, 5 and 10 ppm TOC, complete killing is seen after 60 minutes at rest for both bacteria and virus.

FIGS. 11 and 12 show the comparative antibacterial and antiviral performances of different sachets shown in FIGS. 1 to 4. In FIG. 11, point (BI) depicts E. coli input concentration, (BO-a) depicts E. coli output concentration of a sachet shown in FIG. 1, (BO-b) depicts E. coli output concentration of a sachet shown in FIG. 2a, (BO-c) depicts E. coli output concentration of a sachet shown in FIG. 3 and (BO-d) depicts E. coli output concentration of a sachet shown in FIG. 4a. In FIG. 12, points (VI) depicts virus input concentration, (VO-a) depicts E. coli output concentration of a sachet shown in FIG. 1, (VO-b) depicts virus output concentration of a sachet shown in FIG. 2a, (BO-c) depicts virus output concentration of a sachet shown in FIG. 3 and (VO-d) depicts virus output concentration of a sachet shown in FIG. 4a. The bacteria and virus in the treated water was screened after 60 minutes as explained in example 1 and 2. FIGS. 11 and 12 show that the complete killing is seen after 60 minutes at rest for both bacteria and virus for all the forms of sachets shown in FIGS. 1 to 4.

FIG. 13 illustrates a water purification unit that is flexible and has either no compartments, or compartments that are adjacent to each other or that are interspersed and/or isolated, in accordance with various aspects of the present invention.

FIG. 14 illustrates a water purification unit that can be used as a filter medium, in accordance with various aspects of the present invention.

FIG. 15 illustrates a water purification unit in the form of a pipe, in accordance with various aspects of the present invention.

FIG. 16 illustrates a water purification unit in the form of a pipe, in accordance with various aspects of the present invention.

FIG. 17 shows the combined fluoride removal and antibacterial performance of a sachet shown in FIG. 2a. The antibacterial and fluoride removal performance of sachet was tested together in 5 L of challenge water as explained in example 10. In FIG. 17, curve (a) and (c) shows input and output E. coli concentration, respectively. And curve (b) and (d) represents input and output concentration fluoride ion, respectively. E. coli at the concentrations of 10⁵ CFU/mL and fluoride ion at the concentration of 8 ppm was taken for study. The bacteria in the treated water was screened after 60 minutes as explained in example 1 and 10. Fluoride ions in the treated water were analyzed as explained in example 3 and 10. The sachet was tested repeatedly for few days. FIG. 17 shows that the complete killing is seen after 60 minutes at rest for bacteria and reduction in fluoride concentration below WHO permissible limit was seen. Hence, it is clear that a sachet can remove different contaminants present in the field water through single contact.

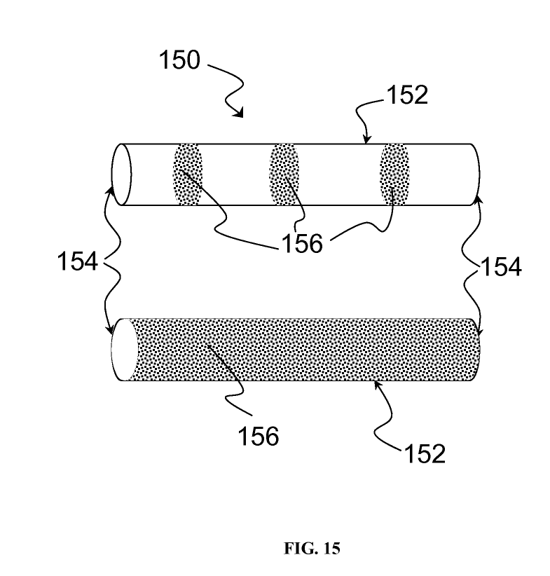

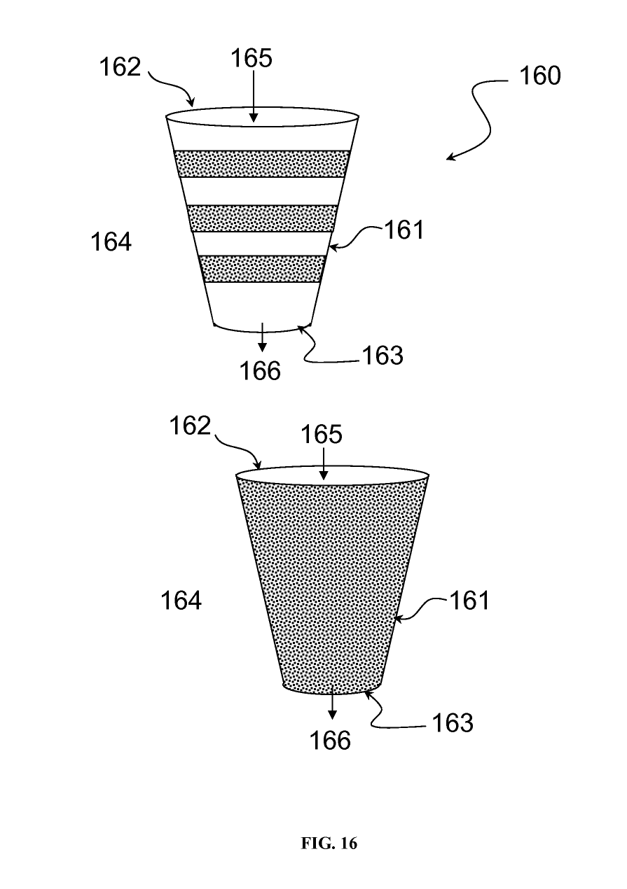

In another aspect, the water purification unit can be in the form of a straw, such that water can pass through and be at least partially purified as it is being consumed from, for example, a cup of water. FIG. 16 illustrates another aspect of that use illustrated in FIG. 15, wherein the pipe does not need to be of a uniform width.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a component” includes mixtures of two or more components.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C—F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As briefly described above, the present invention is directed to a water purification unit, and to various methods of preparing and using the inventive purification unit.

Existing water purification technologies can comprise gravity-fed filtration technologies, in-line technologies, or sachets of material that can be mixed with contaminated water. Delivery of chemicals for water purification in sachets has the advantage of not requiring bulky packaging materials that can hinder transportation and add to the cost of water purification. Some sachet based delivery methods involve pouring the contents of the sachet into the raw water, mixing the solution and filtering it after a prescribed settling time. This works well if the chemicals used for water purification are not reusable and dissolve in water. Such technologies are not well suited to reusable chemicals and/or materials that, for example, do not dissolve in water.

In one aspect, the water purification unit of the present invention comprises a sachet, wherein a material, such as a nanomaterial, is disposed at least partially within the sachet. In one aspect, the disclosure provides a purification unit that is flexible and portable.

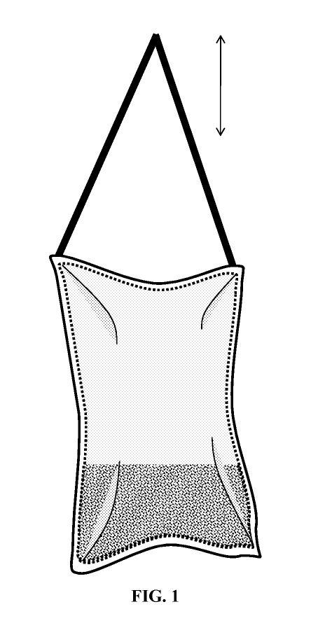

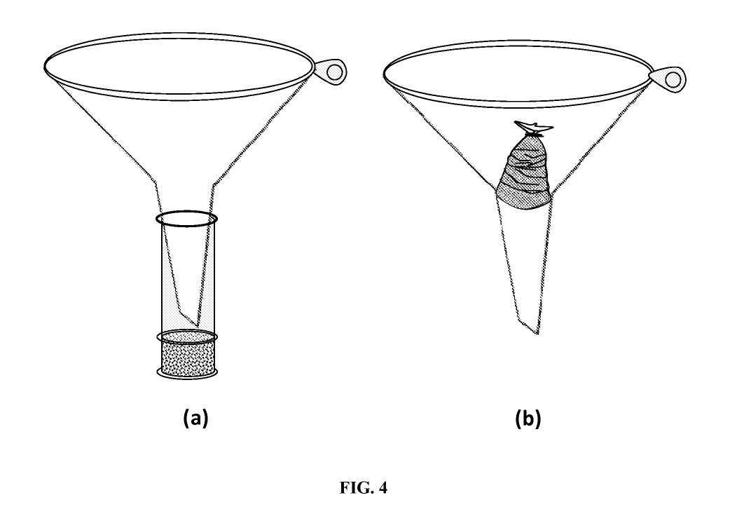

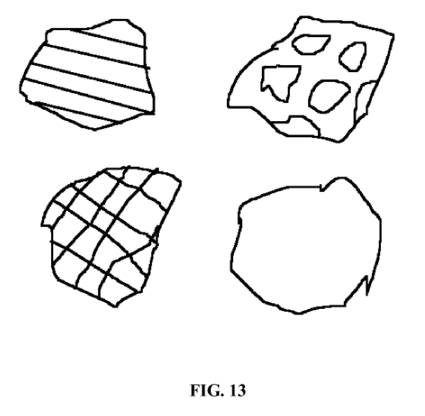

The sachet can comprise any design, size, and/or materials of construction suitable for use in a water purification unit. For example, the sachet can have the design of any of FIGS. 1 to 4. and FIGS. 13 to 16. The Figures are illustrative and not restrictive. It is therefore obvious that any modifications, employing the principles of this invention without departing from its spirit or essential characteristics, still fall within the scope of the invention. Consequently, modifications of design, methods, structure, sequence, materials and the like would be apparent to those skilled in the art, yet still fall within the scope of the invention.

In one aspect, the sachet is made up of porous membrane cloth derived from a natural or synthetic material. A typical example of such a cloth is cotton. The volume (measured by water holding capacity) of the sachet can be any suitable size, and in various examples can vary from 50 mL to 5000 mL, preferably 100 mL to 1000 mL, for example 500 mL or 250 mL. The quantity of water purification composition in the sachet can also be any suitable amount, and in various examples can vary from 1 to 100% of total volume of the sachet, depending on the nature of composition to be used and its mechanism of water purification. In another aspect, the purification composition can comprise from about 50 vol % to about 99 vol % of the sachet.

Any suitable amount of nanomaterial can be present in the sachet, for example, 1%-30% by volume, preferably 1-10% or 2%-5%. In case of antimicrobial composition packed in the design depicted in FIG. 1, a preferable quantity to be used in sachet is 2 to 5%. The nanomaterial in the sachet can release, for example, silver, into the water. In the field, where it is used, the described sachet can be immersed in microbial contaminated water and then lifted out of water, such that water in the sachet can drain through the antimicrobial composition packed in the sachet. In such an aspect, the composition can release trace quantity of silver ions in the water to be treated. The process of immersion-lift-drain can be repeated, to ensure that entire water volume has contacted the composition. The present sachet design is proposed so that the sachet can hold a sufficient quantity of liquid when lifted out of water.

In one aspect, all or a portion of the nanomaterial particles disposed in a sachet is not soluble in water, such that when water contacts the nanomaterial, all or substantially all of the nanomaterial particles remain in the sachet. In another aspect, the nanomaterial particle is not soluble in water, such that upon contact with water, the nanomaterial particle remains disposed in the sachet. In yet another aspect, a portion of the nanomaterial particle can be designed to dissolve in water. In such an aspect, a nanomaterial particle can remain insoluble, but can release a second material, such as, for example, silver ions, into water upon contact.

In one aspect, the nanomaterial particle disposed in a sachet can absorb one or more pollutants or contaminants from a water sample. In another aspect, all or a portion of pollutants and/or contaminants absorbed by a nanomaterial particle, can be removed by, for example, washing, chemical treatment, and/or thermal treatment of the nanomaterial particle. In such an aspect, a water purification sachet can be reusable, wherein after use the sachet can be treated to regenerate and/or restore all or a portion of the absorbent properties thereof.

In one aspect, the sachet comprises a porous material that can allow contaminated water to flow through and/or permeate at least a portion of the bag. In various aspects, the sachet can comprise a net, a woven material, a non-woven material, a paper and/or cellulosic material, a polymeric material, or a combination thereof. In one aspect, the sachet comprises a porous paper. In another aspect, the sachet comprises a polymeric material.

The porosity and/or permeability of the sachet can vary, provided that the nanomaterial disposed therein can be contained so as to not be dispersed in water outside of the sachet and that water can flow through and/or permeate the material so as to contact the nanomaterial.

The size and dimensions of a sachet can vary depending on a particular application, such as, for example, the amount of water to be treated.

In one aspect, the sachet and/or material from which it is constructed is flexible. In other aspects, the pores and/or openings of a sachet are dimensioned such that all or substantially all of the nanomaterial disposed with a sachet remains in the sachet upon contact with water. In another aspect, the pores and/or openings of a sachet are dimensioned such that all or substantially all of the pores and/or openings are smaller than at least a portion of the nanomaterial particles.

In another aspect, the sachet itself can comprise a functional component, such as, for example, a functionalized polymer, a material comprising nanomaterial (e.g., attached to the surface thereof, disposed within, etc.), or a combination thereof, such that the sachet itself can absorb and/or adsorb and/or neutralize one or more pollutants or contaminants in a water sample.

In another aspect, the sachet can form a sensor or a portion of a sensor that can, for example, detect pollutants and/or contaminants, such as by a color change in the presence or absence of one or more contaminants.

In one aspect, a plurality of nanomaterial particles are disposed within the sachet. In another aspect, at least a portion of the nanomaterial particles are capable of adsorbing and/or absorbing and/or neutralizing one or more contaminants that can be present in a water sample. The composition of the nanomaterial particles can vary, depending on, for example, the specific contaminants to be removed, and a combination of different nanomaterial particles can also be disposed in a sachet.

In one aspect, a nanomaterial can comprise a metal nanoparticle, such as, for example, gold, silver, and/or copper particles. In a specific aspect, such particles can have an average diameter of from about 2 nm to about 150 nm. In another aspect, the particles can be disposed on the surface of alumina particles by, for example, soaking alumina particles having an average diameter of about 0.5 cm in a solution of metal nanoparticles, for example, about 10⁻³ moles/liter, for a period of time. After soaking, the resulting particles can be washed.

In another aspect, the nanomaterial can comprise a boehmite nanoarchitecture, for example, prepared using an organic template that can assist growth of particles by exposing high-index planes and bind particles together. In such an aspect, such particles can remove arsenic, fluoride, and/or viruses, among other contaminants. In such an aspect, a granular hybrid adsorbent comprising an organic template and a nanoscale material of metal-oxyhydroxide, such as, for example, boehmite having an average particle size of less than about 10 nm, can be used.

In such an aspect, the organic template can comprise a polymer and/or a biopolymer such as chitosan that can allow particles to be grown on at least a portion thereof.

In another aspect, the nanomaterial can exhibit a high ion exchange capability and/or a high surface area. In various aspects, the nanomaterial can comprise alumina, boehmite, nanowires, nanotubes, nanosheets, nanobelts, nanofibers, nanoflowers, nanoflakes, nanorods, or a combination thereof.

In another aspect, the nanomaterial can comprise any one or more nanomaterials such as those recited in U.S. Pat. Nos. 7,449,030, 4,250,058, or a combination thereof, which are hereby incorporated by reference for the purpose of disclosing nanomaterials. In another aspect, the nanomaterial can comprise any other nanomaterial or combination of nanomaterials known in the art to adsorb and/or absorb a contaminant.

In one aspect, the nanomaterial can comprise OTBN, which can be prepared as described in PCT patent application PCT/IB2011/001551, which is hereby incorporated in its entirety by reference. The OTBN gel obtained after washing the salt content is used for the formation of silver nanoparticles. The OTBN gel can again be re-dispersed in water, to which 1 mM silver precursor (silver nitrate, silver fluoride, silver acetate, silver permanganate, silver sulfate, silver nitrite, silver bromate, silver salicylate or any combination of the above) can be added. Thus, the nanomaterial can comprise OTBN and silver salt. Suitable silver salts include, but are not limited to silver nitrate, silver fluoride, silver acetate, silver permanganate, silver sulfate, silver nitrite, silver bromate, silver salicylate or any combination of the above. In one aspect, silver nanoparticles can be impregnated on a organic-templated-boehmite nanoarchitecture (OTBN). In one aspect, the amount of Ag to OTBN can be between 0.05-5%, such as between 0.1%-1.5%. In another aspect, the amount of Ag to OTBN can be at least about 0.1%, 0.25%, 0.5%, 0.75%, 1.0%, 1.5%, 2.0%, 2.5%, 3.0%, 3.5%, 4.0%, or 5.0%. In another aspect, the amount of Ag to OTBN can be less than 0.1%, 0.25%, 0.5%, 0.75%, 1.0%, 1.5%, 2.0%, 2.5%, 3.0%, 3.5%, 4.0%, or 5.0%.

In one aspect, the nanomaterial comprises reduced graphene oxide sheets (RGO). For example, the nanomaterial can comprise RGO-metal/metal oxide nanocomposite, such as, for example, those described in PCT application PCT/IB2011/002740, which is hereby incorporated by reference for the purpose of teaching RGO-metal/metal oxide nanocomposites. The nanomaterial can further comprise a polymer, such as chitosan. Suitable nanomaterials include, but are not limited to RGO-MnO₂/RGO-Ag. The RGO-MnO₂/RGO-Ag can be in a chitosan matrix

The nanomaterial disposed in the sachet can be disposed in and optionally sealed in at least a portion of the sachet such that the nanomaterial can remove one or more contaminants in a water sample when the sachet is disposed therein. In such an aspect, water can pass through the pores and/or openings of the sachet to contact the nanomaterial. In another aspect, a sachet can comprise a plurality of individual compartments separated so as to keep a portion of the nanomaterial separate from another portion of the nanomaterial.

In another aspect, the nanomaterial can comprise a composite material of a metal oxide, based on, for example, manganese and/or zinc. In another aspect, such a composite can be disposed and/or loaded on a cellulosic or other material, such as, for example, chitosan, rice husk ash, activated carbon, activated alumina, or a combination thereof. In another aspect, such a nanomaterial can comprise an oxide composite of manganese and zinc, having an average particle size of less than about 500 nm and/or an average plate thickness of less than about 15 nm. In another aspect, the nanomaterial can be prepared from hydrolysis of metal precursors based on zinc and manganese using an alkaline medium in the presence of a template such as a biopolymer. In various aspects, a metal precursor can comprise zinc nitrate, zinc chloride, zinc chloride, zinc acetate, manganese nitrate, manganese sulfate, manganese acetate, or a combination thereof. In another aspect, the alkaline medium can comprise sodium hydroxide, ammonia, potassium hydroxide, sodium bicarbonate, or a combination thereof.

In another aspect, the nanomaterial can comprise a porous composite axial block that can otherwise be used in, for example, a gravity fed filtration system, such as, for example, that described in PCT patent application PCT/IB2011/002790, which is hereby incorporated by reference for the purpose of teaching a gravity fed filtration system.

In such an aspect, the composite axial block can comprise an active filtration media, such as, for example, activated carbon, activated charcoal, activated alumina, sand, metal oxide/hydroxide nanoparticles loaded on activated alumina and/or carbon, metal nanoparticles loaded on activated alumina and/or carbon, ion exchange resin, and/or any composition of micron sized metal oxides such as silica, titania, magnesia, manganese oxide, zeolites, boehmite, iron oxide-hydroxide, or a combination thereof.

In another aspect, the nanomaterial can comprise a high surface area material, such as, for example, a graphene based material. In one aspect, the nanomaterial can comprise a reduced graphene oxide based composite. In another aspect, such a nanomaterial can be immobilized on another material such as, for example, river sand, optionally using a binder such as chitosan.

In one aspect, a sachet comprising a plurality of nanomaterial particles can be disposed in a container either containing water and/or designed to be at least partially filled with water. In one aspect, the sachet is positioned in a container comprising water. In another aspect, the sachet is positioned in a container that will be filled with water.

The sachet can remain in the container for a period of time to allow the water and nanomaterial sufficient contact to remove at least a portion of the contaminants. In various aspects, the period of time can range from a period of minutes to hours. In a specific aspect, the sachet can remain in the container for a period of time, such as, for example, that needed to return from a water source to a residence or point of use.

In one aspect, no specific mixing is required. In another aspect, the water and/or container comprising water and sachet can be mixed, for example, stirred and/or shaken, to improve contact between the water and nanomaterial. In another aspect, natural motion from, for example, walking and/or carrying a container of water can be sufficient.

In one aspect, at least a portion of one or more contaminants can be removed from the water. In various aspects, the contaminants can comprise heavy metals, organic compounds, halogenated materials, pesticides, herbicides, other contaminants, or a combination thereof.

In another aspect, the water, after contacting with the sachet and nanomaterial for a period of time, can have a reduced level of one or more contaminants. In another aspect, the level of one or more contaminants can be reduced to a level safe for human consumption.

In one aspect, the sachet and nanomaterial can be removed from the water sample and/or container. In another aspect, the sachet and nanomaterial can be allowed to remain in the container and optionally in contact with a water sample.

In another aspect, the sachet and/or sachet comprising nanomaterial particles can act as a filtration device.

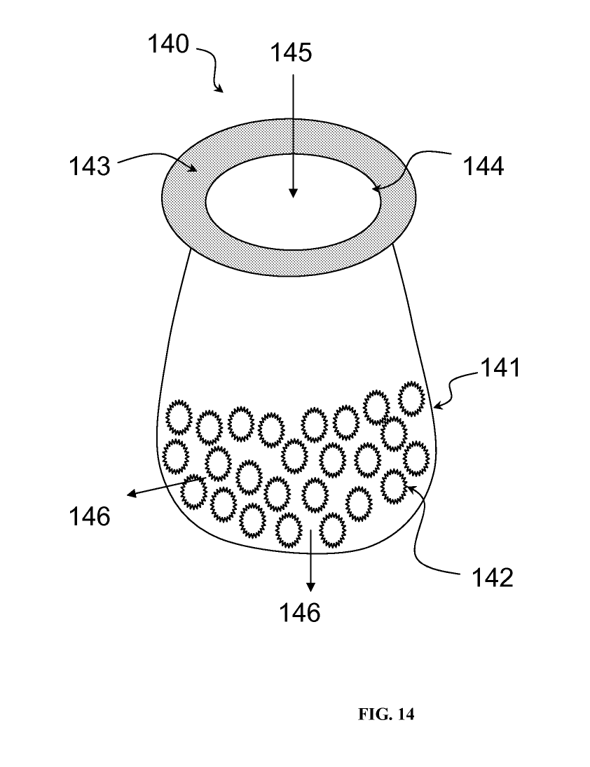

In other aspects, the sachet can be used as a filter medium, as illustrated in FIG. 14. In this aspect, the sachet can be attached, for example, to a water supply such as a faucet, or to the mouth or opening of a vessel prior to filling with water. In such an aspect, a flexible gasket can be used as a drawstring that can be pulled to tighten it around the opening. An optional flap can provide additional strength when used at the mouth or opening of a vessel to hold it in place and prevent slipping. In one aspect, if placed at the opening of a vessel, additional sachets of the same or differing composition and design can be positioned on other areas, for example, the sides of a vessel, to increase the amount of nanomaterial available for purification, and thus purify the water as it is being carried from a source point to a point of use. With reference to FIG. 14, contaminated water 145 can be introduced into an opening of a sachet 140 formed from a flexible or porous material 141, having an optional flap 143 and flexible gasket 144. Upon contact with a plurality of nanomaterial particles 142 disposed within the sachet, the water can be at least partially purified, resulting in a purified water 146 source.

In another aspect, the water purification unit can be in the form of a flexible and/or inflexible pipe, as illustrated in FIGS. 15 and 16. In such an aspect, a pipe can be fitted to pump water, for example, from a ground water source such that it at least partially purifies the water as it flows through the pipe. In another aspect, a water purification unit can be in the form of a pipe that can be connected, for example, to a hand pump outlet such that water flows through the pipe to a container as the container is being filled. With reference to FIG. 15, a pipe 150 can be formed from a non-porous material 152. Optional gaskets 154 can be positioned at one or both ends of the pipe. The pipe can contain a single or multiple sachets 156 of nanomaterial particles disposed within the pipe, for example, in contact with the interior walls of the pipe to provide a means for purifying water flowing through the pipe.

In another aspect, the water purification unit can be in the form of a straw, such that water can pass through and be at least partially purified as it is being consumed from, for example, a cup of water. FIG. 16 illustrates another aspect of that use illustrated in FIG. 15, wherein the pipe does not need to be of a uniform width. In such an aspect, the sachets can be, for example, stacked inside the pipe or fully embedded and/or layered inside the pipe, or in another aspect, can be the pipe itself. In another aspect, the water purification unit can be in the form of a straw, wherein the straw comprises one or more internal portions thereof designed to hold a plurality of nanomaterial particles as described herein. In one aspect, the internal portion of the straw can comprise porous dividers between internal sections of the straw. In a specific aspect, a water purification unit can comprise a straw, for example, a plastic straw, wherein the interior portion of the straw has at least two sets of dividers to contain the nanomaterial particles. In such an aspect, water can flow through the dividers and contact the nanomaterial particles before exiting the straw. In various aspects, the dividers, if present, can be formed from the same material as the straw, for example, during molding or extrusion, or can be inserted into the straw in a secure manner. With reference to FIG. 16, a purification unit 160 can be formed from a non-porous material 161 having an optional flexible entry gasket 162 and/or an optional flexible exit gasket 163. One or more sachets 164 of nanomaterial particles can be disposed in the unit, for example, as a plurality of discrete layers or as a single sachet filling all or substantially all of the unit's volume. Contaminated water 165 can be introduced at the opening of the unit and allowed to contact the one or more sachets 164 so as to produce a purified water source at the exit.

In one aspect the sachet comprising the nanomaterial can have antimicrobial properties. For example, the sachet can reduce the amount of bacteria, virus or fungi by at least 60%, 70%, 80%, 90%, 95%, 96%, 97%, 98%, 99%, or 99.9% in a water sample. Preferably, the sachet reduces the amount of bacteria, virus or fungi 90%, 95%, 96%, 97%, 98%, 99%, or 99.9% in a water sample. The water sample can have volume with a specified amount of microbes, such as bacteria, virus or fungi. For example, the water sample, can have a microbial amount of 3×10³±50 PFU/mL, 1×10⁵±1000 CFU/mL, 1×10⁴±100 CFU/mL, or 1×10³±10 CFU/mL.

In one aspect the sachet comprising the nanomaterial can remove heavy metals from a water sample. For example, the sachet can reduce the amount of heavy metals by at least 60%, 70%, 80%, 90%, 95%, 96%, 97%, 98%, 99%, or 99.9% in a water sample. Preferably, the sachet reduces the amount of heavy metals by 90%, 95%, 96%, 97%, 98%, 99%, or 99.9% in a water sample. Such heavy metals that can be reduced in concentration include, but are not limited to mercury (such as Hg²), cadmium, lead (Pb²), chromium, iron, cobalt, copper, manganese, molybdenum, arsenic, and zinc.

In one aspect, a sachet comprising the nanomaterial can remove potentially hazardous substances, such as fluoride, from a water sample. For example, the sachet can reduce the amount of potentially hazardous substances, such as fluoride, by at least 60%, 70%, 80%, 90%, 95%, 96%, 97%, 98%, 99%, or 99.9% in a water sample. Preferably, the sachet reduces the amount of potentially hazardous substances, such as fluoride by 90%, 95%, 96%, 97%, 98%, 99%, or 99.9% in a water sample.

In one aspect, the water sample can be contacted with the sachet for a period of time. For example, 1 week, 1 day, 12 hrs, 6 hrs, 3 hrs, 1.5 hrs, 1 hr, 30 min or 15 min. In one aspect, the period of time can be sufficient for the sachet to reduce the amount of microbial materials in a contaminated water sample. In one aspect, substantially all of the water in the water sample contacts at least a portion of the nanomaterial in the sachet.

In one aspect, the water can be stirred within the sachet. For example, a rod can stir the water thereby maximizing the contact between the volume of water and the nanomaterial. In one aspect, the rod can be coated with antimicrobial material described herein. For example, the rod can be coated with a thermoplastic binder that is used to coat the granular antimicrobial material on the rod. In another aspect, a layer of antimicrobial material sandwiched in between two porous membranes is attached around the rod.

In an aspect, the water purification composition is crushed to fine particle to increase the surface area and can be coated on the stirring rod. In an aspect such as antimicrobial rod, the water purifying rod can be used for defined number of times. For example, at least 10, 25, 50, 100, 500 or 1000 times. The sachet can be effective for at least a period of time, for example, 1 day, 3 days, 5 days, 1 week, 2 weeks, 1 month, 3 months, 6 months or 1 year.

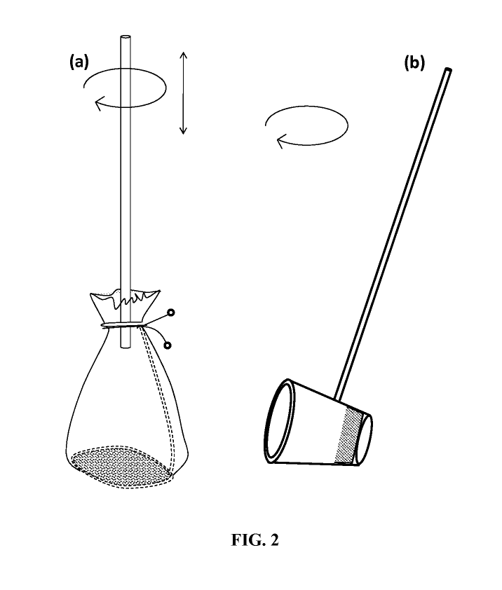

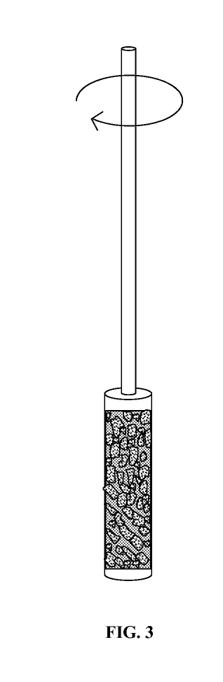

In case of antimicrobial composition packed in the design depicted in FIG. 2a and FIG. 2b, a preferable quantity of composition to be used in sachet is 4 to 10%. While not wishing to be bound by theory, it is to be noted that the Ag-OTBN composition can work on the concept of constant silver release through its release kinetics which can be considered to be fast or very fast. The described sachet attached to a rod is designed in such a way that it does not shrink when stirred in contaminated water. In the field, where it is used, the sachet can be stirred vigorously for 3 to 10 minutes, preferably 5 minutes, to ensure effective contact.

In another aspect, the water purifying rod can be a use and throw system depending upon the nature of the contaminant and its removal mechanism.

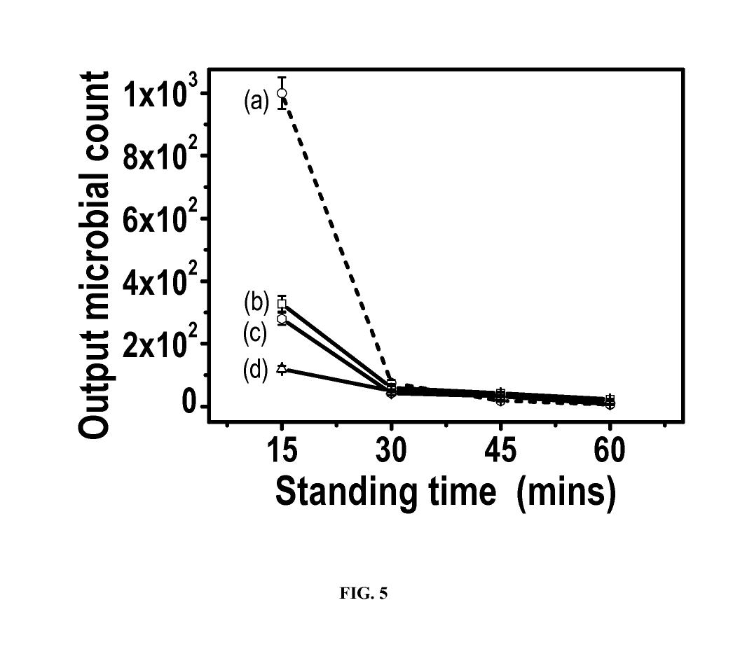

In another aspect, the nanomaterial, such as an antimicrobial composition, can be packed in the design, such as or similar to that shown in FIG. 4a and b. In such an aspect, contaminated water can be passed through the material at a designated flow rate. In various aspects, the flow rate can be for example, 100 to 3000 mL/min, 200 to 2000 mL/min or 400 to 1500 mL/min. In another aspect, the flow rate can be about 700 mL/min. In yet another aspect, the present design is proposed so that the sachet becomes small in size and can be used in a different place.

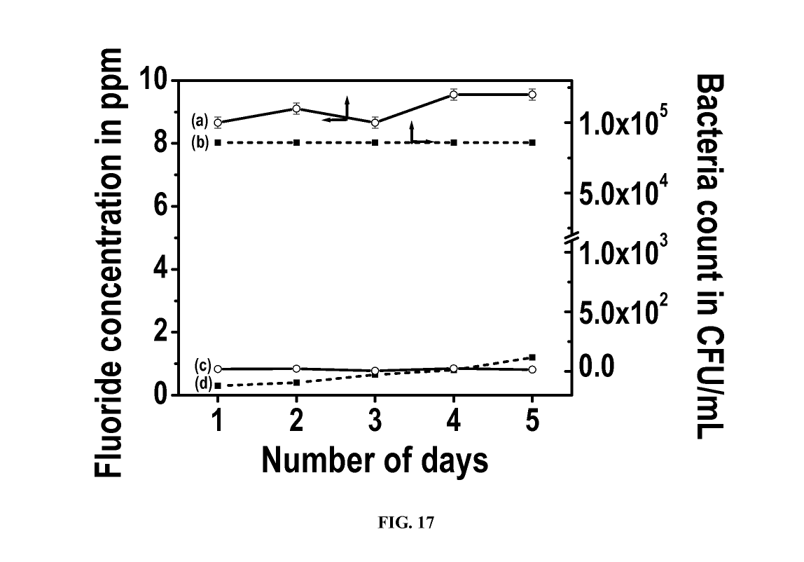

In one aspect, the sachet can remove two or more contaminates. For example, the sachet can remove at least any two or more combinations of antibacterial, antiviral, heavy metal removal, fluoride removal and pesticide removal media. For example, the data in FIG. 17, shows that the sachet can have both antibacterial and fluoride removal properties. In another aspect, the sachet can remove the same or different amounts of different contaminates. For example, the sachet can remove 99% of bacterial and 99.9% of fluoride present in a contaminated water sample.

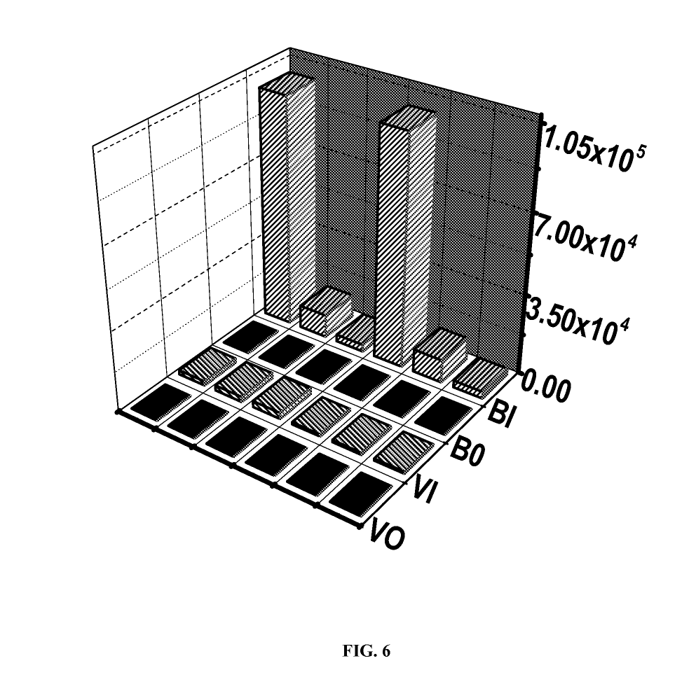

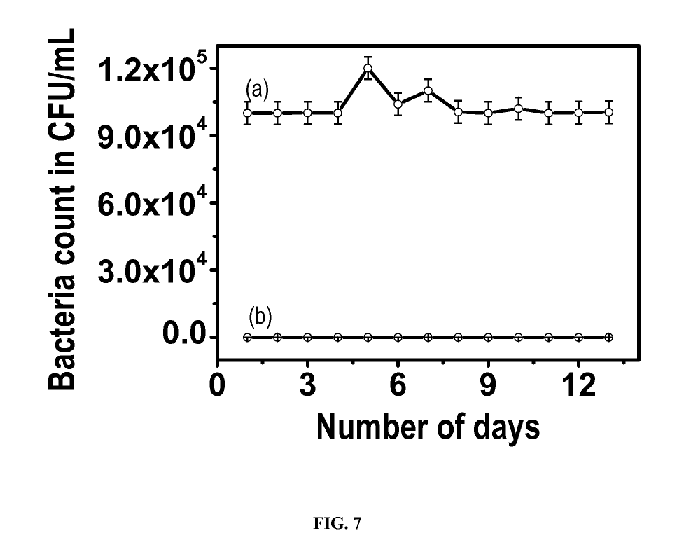

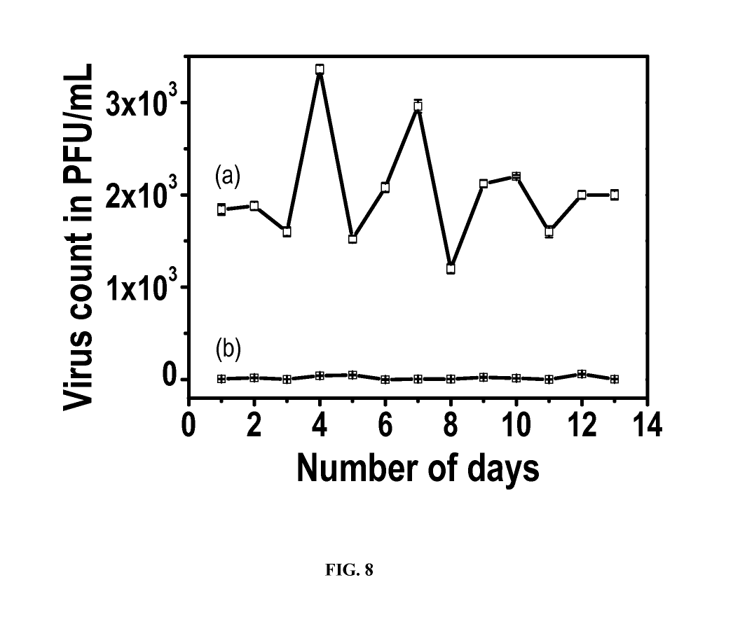

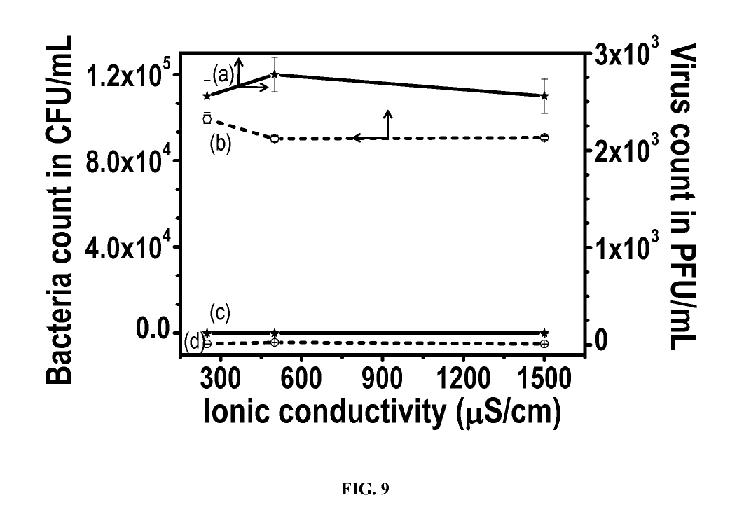

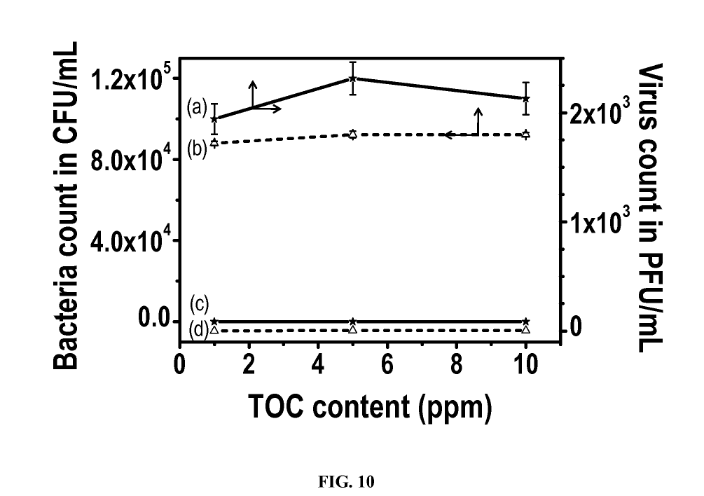

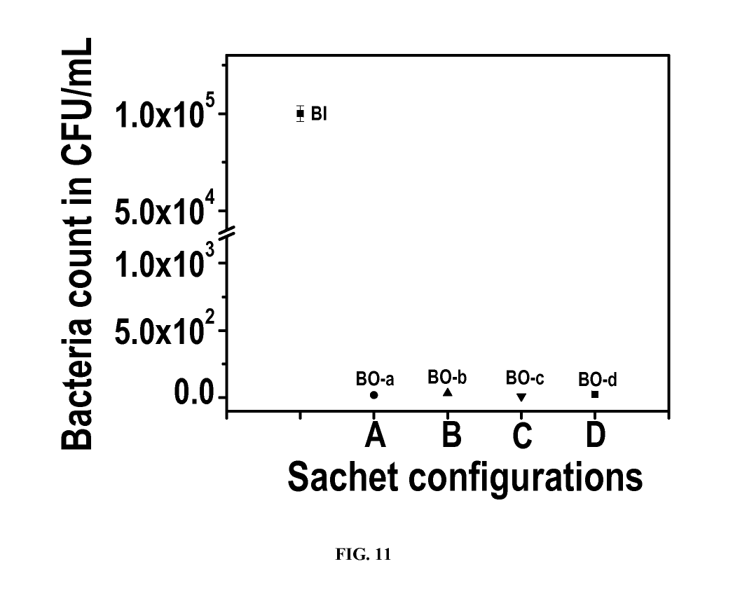

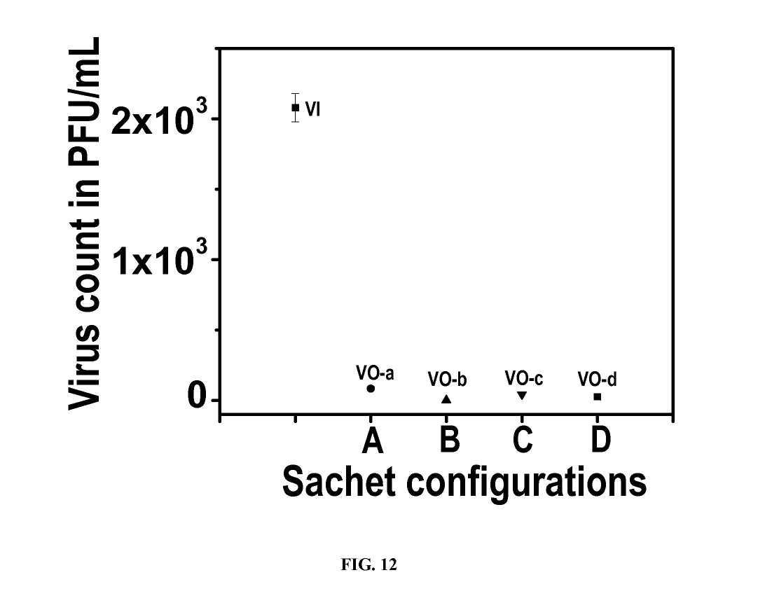

It should also be noted that the performance data given in FIGS. 5 to 11 are not subjected to any one form of sachet but common for all the forms of sachets shown in FIGS. 1 to 4 and FIGS. 13 to 16.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Several methods for preparing the devices, methods and uses thereof as described herein are illustrated in the following Examples.

### Example 1

This example describes the testing protocol for antibacterial activity of composition packed in a sachet. In an aspect, 5 L of feed water (typically containing E. coli concentration of 1×10⁵ CFU/mL, unless otherwise mentioned) was shaken with the sachet. Challenge water having the specific concentration similar to that prescribed by US NSF for contaminant removal claim was used in the study. After one hour of standing, 1 mL of the sample along with nutrient agar was plated on a sterile petri dish using the pour plate method. After 48 hours of incubation at 37° C., the colonies were counted and recorded.

### Example 2

This example describes the testing protocol for antiviral activity of composition packed in a sachet. In an aspect, 5 L of feed water (typically containing MS2 coliphage concentration of 1×10³ PFU/mL, unless otherwise mentioned) was shaken with the sachet. Challenge water having the specific concentration of ions similar to prescribed by US NSF for contaminant removal claim was used in the study. After one hour of standing, 1 mL of the sample was plated by plaque assay method. After 24 hours of incubation at 37° C., the colonies were counted and recorded.

### Example 3

This example describes the testing protocol for fluoride removal performance of adsorbent composition packed in a sachet. In an aspect, 5 L of feed water (typically containing F- at the concentration of 8 ppm) was shaken with the sachet. Challenge water having the specific concentration similar to that prescribed by US NSF for contaminant removal claim was used in the study. After contacting with sachet, sample was collected and analyzed using fluoride ion selective electrode or ion chromatography.

### Example 4

This example describes the testing protocol for heavy metal removal performance of adsorbent composition packed in a sachet. In an aspect, 5 L of feed water (typically containing heavy metals such as Hg2+ and Pb2+ at the concentration of 150 ppb) was shaken with the sachet. Challenge water having the specific concentration similar to that prescribed by US NSF for contaminant removal claim was used in the study. After contacting with sachet, sample was collected, acidified and analyzed using ICP-MS.

### Example 5

This example describes the testing protocol for pesticide removal performance of adsorbent composition packed in a sachet. In an aspect, 5 L of feed water (typically containing pesticide such as chlorpyrifos and malathion at the concentration of 10 ppb) was shaken with the sachet. Challenge water having the specific concentration similar to that prescribed by US NSF for contaminant removal claim was used in the study. After contacting with sachet, sample was collected, extracted with suitable organic solvent and analyzed using GC-MS.

### Example 6

This example describes the testing protocol for mixed composition sachet which can house two or more water purification compositions such as OTBN, silver nanoparticles impregnated OTBN, RGO-metal/metal oxide nanocomposites, etc. In an aspect, the required media are mixed together and packed inside a desired sachet. In an aspect, 5 L of feed water (typically containing F at the concentration of 8 ppm and E. coli at the concentration of 1×10⁵ CFU/mL) was shaken with the sachet. Challenge water having the specific concentration similar to that prescribed by US NSF for contaminant removal claim was used in the study. After one hour of standing, 1 mL of E. coli sample along with nutrient agar was plated on a sterile petri dish using the pour plate method. After 48 hours of incubation at 37° C., the colonies were counted and recorded. And, sample for fluoride ion analysis was collected and analyzed using fluoride ion selective electrode or ion chromatography.

### Example 7

This example describes the synthesis of antibacterial and antiviral water purification compositions that can be used in a sachet. The synthetic method comprises the in-situ impregnation of silver nanoparticles on the OTBN as explained in Indian application No. 947/CHE/2011, wherein the OTBN can be prepared as described in PCT application No. PCT/IB2011/038968. The OTBN gel obtained after washing the salt content is used for the formation of silver nanoparticles. The OTBN gel is again re-dispersed in water, to which 1 mM silver precursor (silver nitrate, silver fluoride, silver acetate, silver permanganate, silver sulfate, silver nitrite, silver bromate, silver salicylate or any combination of the above) is added drop-wise. The weight ratio of Ag to OTBN can be varied anywhere between 0.1-1.5%. After stirring the solution overnight, 10 mM sodium borohydride is added to the solution drop wise (in ice-cold condition, temperature <5° C.). Then, the solution was allowed to stir for half an hour, filtered and washed with copious amount of water. The obtained gel is then dried at room temperature for further studies.

### Example 8

This example describes the synthesis of fluoride removal adsorbent media that can be used in a sachet. The synthetic method comprises the room temperature synthesis of nanoscale-A100H through a simple soft chemistry route as described in PCT application No. PCT/IB2011/038968. The synthesis procedure consists of mixing the aluminum precursor solution with chitosan (dissolved in 1-5% glacial acetic acid or HCl or combination thereof) with vigorous stirring. In a general procedure, a solution of aluminum precursor such as aluminum nitrate was added slowly into the chitosan solution with vigorous stirring for 60 minutes and was kept overnight without agitation. Aqueous ammonia or NaOH solution was slowly added into the metal-chitosan solution with vigorous stirring to facilitate the precipitation of the metal-chitosan composites (pH 7-8.0). All these steps were carried out at temperature below 30° C. Stirring was continued for two hours. The precipitate was filtered, washed to remove any unwanted impurities, converted in the shape of beads and dried at various conditions.

### Example 9

This example describes the synthesis of heavy metal removal adsorbent media that can be used in a sachet. The synthetic method comprises the synthesis of RGO-metal/metal oxide nanocomposites as described in PCT application No. PCT/IB2011/002740, which is incorporated herein in its entirety by reference. Briefly, 1) graphite oxide (GO) was synthesized from graphite powder as explained in literature. 2) after exfoliation of GO by sonication, 35 wt % aqueous hydrazine hydrate solution followed by 28 wt % aqueous ammonia solution were added under vigorous stirring and heated at 90° C. for 2 hours to reduce GO to reduced graphene oxide sheets (RGO) as explained in literature. 3) To 25 mL of RGO solution, calculated volumes of metal ion precursors (KMnO₄, HAuCl₄, AgNO₃, H₂PtCl₆, PdCl₂, etc.) were added such that the final concentration in the solution was 0.01, 0.025, 0.05, 0.1, 0.3 mM, etc. The mixtures were incubated for 12 h at 30° C. and were put for dialysis against distilled water for 5 days. 4) After dialysis, the synthesized RGO-metal/metal oxide nanocomposites were supported on suitable matrix. In order to support RGO composites on silica, the following protocol was adopted. To the chitosan solution (0.8% chitosan in 1.5% acetic acid), as-prepared RGO-MnO₂/RGO-Ag was added in 1:1 ratio under vigorous stirring. 25 mL of the homogeneous dispersion was added to 10 g of silica and mixed thoroughly. The mixture was dried at about 40° C. under constant stirring to ensure uniform coating. To stabilize the coating, the dried samples were soaked in 35 wt % aqueous ammonia solution for an hour and washed with distilled water to pH 7. The materials were dried at 40° C. and stored in glass bottles for further use.

### Example 10

This example describes the utilization of silver nanoparticles loaded metal oxide in a sachet for removal of pesticides such as chlorpyrifos and malathion as described in Indian Patent 200767 and PCT Application PCT/IN05/0002. Briefly, silver nanoparticles was prepared as explained in literature and loaded on support matrix such as activated alumina and activated carbon.

The sachet described in example 1 to 6 can have a design configuration chosen amongst from FIGS. 1 to 4 or FIGS. 13 to 16. And the method in which it is contacted with contaminated water differs from one configuration to another configuration. The detailed method of contact for each sachet is given below.

### Example 11

This example describes the testing protocol for mixed composition sachet which can house two or more water purification compositions such as OTBN, silver nanoparticles impregnated OTBN, RGO-metal/metal oxide nanocomposites, etc. In an aspect, the required media are mixed together and packed inside a desired sachet. In an aspect, 5 L of feed water (typically containing F at the concentration of 8 ppm and E. coli at the concentration of 1×10⁵ CFU/mL) was shaken with the sachet. Challenge water having the specific concentration similar to that prescribed by US NSF for contaminant removal claim was used in the study. After one hour of standing, 1 mL of E. coli sample along with nutrient agar was plated on a sterile petri dish using the pour plate method. After 48 hours of incubation at 37° C., the colonies were counted and recorded. And, sample for fluoride ion analysis was collected and analyzed using fluoride ion selective electrode or ion chromatography.

What is claimed is:

1. A sachet comprising a plurality of nanomaterial particles.

2. The sachet of claim 1, wherein at least a portion of the nanomaterial particles can remove at least a portion of a contaminant from a water sample when contacted therewith.

3. The sachet of claim 2, wherein the nanomaterial particles can reduce the amount of contaminate from the water by at least 90%.

4. The sachet of claim 2, wherein the contaminate comprises bacteria, virus or fungi, or a mixture thereof.

5. The sachet of claim 2, wherein the contaminate comprises a heavy metal.

6. The sachet of claim 1, wherein the nanomaterial comprises organic-templated-boehmite nanoarchitecture (OTBN).

7. The sachet of claim 6, wherein the nanomaterial comprises a silver salt.

8. The sachet of claim 7, wherein the silver salt comprises silver nitrate, silver fluoride, silver acetate, silver permanganate, silver sulfate, silver nitrite, silver bromate, or silver salicylate or a mixture thereof.

9. The sachet of claim 1, wherein the nanomaterial comprises a reduced graphene oxide (RGO)-metal/metal oxide nanocomposite.

10. A method for treating a water sample, comprising contacting a sachet comprising a plurality of nanomaterial particles with a contaminated water sample.

11. A water purification unit, comprising a sachet that acts as at least one of a sensor, a purifier, or a combination thereof.

12. The water purification unit of claim 7, wherein the unit is capable of detecting the presence of at least one contaminant in a water sample and, after sufficient contact between the water sample and the water purification unit or a portion thereof, providing an indicator that the water sample is safe for consumption.
